(19) United States
(12) Patent Application Publication
(10) Pub. No.: US 2018/0183752 A1
(43) Pub. Date: Jun. 28, 2018

(54) METHOD AND SYSTEM FOR PROVIDING ADDITIONAL INFORMATION RELATING TO PRIMARY INFORMATION

(71) Applicant: Solute GmbH, Karlsruhe (DE)

(72) Inventors: Lorenz Petersen, Roeschwoog (FR); Gunter Bach, Weingarten (DE)

(21) Appl. No.: 15/404,934

(22) Filed: Jan. 12, 2017

(30) Foreign Application Priority Data
Dec. 23, 2016 (EP) 16 206 711.0

(51) Int. Cl. H04L 29/12; H04L 29/06; H04L 29/08

(52) U.S. Cl. CPC H04L 61/1558; H04L 67/32; H04L 67/42

(57) ABSTRACT

A method for providing additional information relating to primary information accessible via a network, preferable the Internet, is disclosed. The method comprises the steps of: accessing or referencing primary information by an application using address information, said application running on a user equipment, said user equipment running an operating system, extracting said address information via a system interface provided by said operating system, thus generating extracted address information, wherein said extracted address information is part of a data object generated by said system interface, forwarding said extracted address information to a retrieving entity, retrieving additional information based on said extracted address information by said retrieving entity, and forwarding said additional information back to the user equipment for further processing. Besides that, an according system and a computer program product is disclosed.

### CROSS-REFERENCE TO RELATED APPLICATIONS

This application claims priority to and the benefit of European Application No. 16 206 711.0, filed Dec. 23, 2016, the contents of which as are hereby incorporated by reference in their entirety.

### BACKGROUND

### Technical Field

The present invention relates to a method and a system for providing additional information relating to primary information accessible via a network, preferable the Internet. The present invention additionally relates to a computer program product for implementing the method.

### Description of Related Art

In recent years, a great variety of user equipment providing access to information via a network were released. Stationery devices, like personal computers, are still commonly used, although mobile devices, like laptops, tablet computers or smart phones, are replacing stationery devices in many cases. When accessing information, at least one application is running on the user equipment. The application accesses the desired information via the network and displays it to the user. In many cases the network is formed by the Internet, while access to this network is provided by various wired or wireless techniques.

One of the most relevant sources of information is formed by the World Wide Web that provides a plurality of websites. Each of these websites is accessible via address information, generally URL (Uniform Resource Locator). Although many websites are linked to each other, the need for obtaining additional information relating to currently accessed information arises frequently.

According to one application scenario, a source of additional information might be a dictionary. Here, primary information may be words, sentences or other parts of a website. Additional information may be formed by translations or definitions retrieved from the dictionary.

Another application scenario refers to the accession of a shopping website, where it is desirable for the user to receive additional information regarding the currently accessed product. Such additional information might comprise cheaper offers of another retailer, reviews of the product by other customers or testing companies, or similar products with better availability.

Due to the great variety of applications used for accessing primary information, the systems or methods for providing additional information should be very universal. However, known systems and methods are very limited regarding the area of application. One system known in the art is based on add-ons of a web browser. However, such add-ons always depend on a specific web browser. In many cases, add-ons are even incompatible with different releases of the same web browser. Such an approach cannot cover primary information that are accessed via other applications, such as apps installed on a mobile device.

### BRIEF SUMMARY

It is therefore an object of the present invention to provide a method and a system that enables access to additional information in a universal way.

In accordance with the invention, the aforementioned object is accomplished by a method comprising the features of the broadest method-based claim. According to this claim, such a method comprises the steps of: providing a retrieving entity and a user equipment, said user equipment comprising a processor and an operating system, said operating system comprising a system interface; accessing or referencing primary information via an application using address information, said application running on said user equipment and being executed by said processor; extracting said address information via the system interface, thus generating extracted address information; generating a data object via the system interface, wherein said data object comprises said generated extracted address information; transmitting said extracted address information to said retrieving entity; retrieving, via execution of the retrieving entity, additional information based on said extracted address information; and transmitting said additional information to said user equipment for further processing.

Regarding the system and in accordance with the invention, the aforementioned object is accomplished by a system comprising: a user equipment running an operating system and at least one application, wherein said at least one application is configured to access said primary information via said network using address information; a monitoring entity, said monitoring entity running on said user equipment and being configured to generate extracted address information by extracting said address information via a system interface provided by said operating system, wherein said extracted address information is part of a data object generated by said system interface; a retrieving entity; and a forwarding entity configured to transmit said extracted address information to said retrieving entity, wherein said retrieving entity is configured to retrieve additional information based on said extracted address information and to transmit said additional information to said user equipment for further processing.

According to the invention it has first been recognized that a universal approach might be formed by using certain system interfaces of operating systems. The user equipment used in connection with the present invention always runs an operating system. This operating system interfaces the different applications with the hardware of the user equipment and coordinates the applications and the respective inter-process communication. Many of these operating systems provide system interfaces that can access content of an application. One example of such a system interface is formed by enhanced accessibility functions that primarily support persons with reduced ability to see at using the user equipment. Another example of such a system interfaces is formed by user interface automation functions which are generally used for script controlled execution of applications. Some embodiments of such system interfaces and their respective benefits will be discussed hereinafter. These system interfaces may not only be used for their primary purpose, but may also be used at extracting information regarding primary information accessed by or referenced in an application. The extracted information may be used at retrieving and providing additional information to the user.

According to the invention such a system interface is used to extract address information from a monitored application. At using such a system interface, data objects are generated that include information contained in the respective application. If the monitored application contains address information referencing to primary information, the data object will contain an element with corresponding address information. Thus, extracted address information can be obtained as part of a data object generated by the system interface. Although different applications may generate different data structures, address information can be extracted without difficulty. As such system interfaces are not limited to certain applications but are applicable at a great variety of applications, the method according to the invention can be used very universally.

In a further step, the extracted address information is forwarded to a retrieving entity. The retrieving entity retrieves additional information based on the extracted address information. In many cases, the extracted address information contains sufficient data so that potentially relevant additional information can be determined easily. In other cases, the retrieving entity may also access the referenced primary information in order to obtain further details regarding relevant additional information. The link between primary information and additional information depends on the desired additional information. In cases, where product reviews or price comparison is desired, the link between primary and additional information will be different than in cases, where weather information, water temperature, snow depth, opening hours or technical background are desired. These examples show the great potential of the method according to the invention.

After retrieving additional information, the additional information is forwarded back to the user equipment. At the user equipment the additional information is further processed. In many cases, further processing may include displaying at least parts of the retrieved additional information to a user of the user equipment.

The system according to the invention comprises a user equipment, a monitoring entity, a retrieving entity, and a forwarding entity. The monitoring entity, the retrieving entity and the forwarding entity might be implemented by software or hardware. However, the different entities may also be implemented by a combination of software and hardware, where parts of the hardware might be formed by the hardware of the user equipment.

The user equipment is running an operating system and at least one application, wherein this application is configured to access said primary information via the network using address information. The monitoring entity is running on the user equipment and is configured to generate extracted address information by extracting address information via a system interface provided by the operating system. The forwarding entity forwards extracted address information to the retrieving entity which is responsible for retrieving additional information based on the extracted address information. Additionally, the retrieving entity forwards the additional information back to the user equipment.

Although it is a preferred step of the method according to the invention, that the application accesses primary information, it should be understood that this is not essential for the present invention. It is also possible that the application just contains a reference to the primary information without actually accessing or requesting the primary information.

The monitored application may be formed by a great variety of applications. In connection with the present invention, a web browser might be used as well as other programs or program systems and apps. The application may be formed by an instance of a program, by a sandboxed app, by a tab of a web browser, and by many other applications known in the art. Principally, each application, which can access primary information via a network and which is accessible for the used system interface of the operating system, might be used in connection with the present invention. As this requirement is fulfilled by many applications, the method and system according to the invention can be used universally.

The user equipment might be formed by various stationery or mobile devices. Just to provide a couple of examples without limiting the scope of protection of the present invention, such a user equipment might be formed by a laptop, a personal computer, a tablet computer, a smart phone, and all-in-one pc, a work station, or a netbook. Such a user equipment comprises a processor, RAM (Random Access Memory), non-volatile memory (e.g. flash memory), an interface for accessing a network (e.g. WiFi, LTE (Long Term Evolution), UMTS (Universal Mobile Telecommunications System), or Ethernet), an input device (e.g. a keyboard, a mouse, or a touch sensitive surface) and a display. The operating system controls the different hardware elements and systems and the communication between them.

A great variety of different operating systems may be used in connection with the present invention. As long as the operating system provides a system interface that allows for extracting address information from an application, the operating system will be most likely suitable. Many operating systems provide such a system interface or provide the capability of adding modules or expansion systems. In the latter case, the system interface may be implemented as a module or a system of modules that works closely together with the operating system. Preferred embodiments of such an operating system, however not limited to these examples, are Microsoft Windows, Google Android or Apple iOS.

The address information might be implemented in different ways and will be based on the network and the way information is addressed within this network. In the preferred embodiment of the network by the Internet, the address information is provided by an URI (Uniform Resource Identifier), particularly by an URL (Uniform Resource Locator). Some applications reduce address information considerably. For instance, elements like “https://” or “http://” or “www.” are removed from URLs. Such reductions might complicate retrieval of additional information, as removed information sometimes cannot be restored. If the reduction can be controlled, it might be beneficial to influence the application in such a way that the address information is not reduced. In each other case, the retrieving entity should be adapted so that the shortened address information does not cause any problems.

At the application, the address information may be represented in various ways. It may be visible to the user, e.g. as an address bar of a web browser. However, the address information may also be an internal information, e.g. at a shopping app, where the address information is used, but is not visible to the user. According to a preferred embodiment, the address information is contained in an input box of the application. In such a case, the step of extracting address information comprises reading a text string from this input box of the application. The text string within the input box might be provided by a user of the user equipment. However, the text string might also result from following a hyperlink or other actions.

Preferably, the method according to the invention is performed repeatedly, wherein execution of the method might be triggered in different ways. According to one embodiment, execution is triggered after lapse of a predetermined period of time. Generally, the predetermined period of time is not limited to a specific value. The period of time will be dependent on the update rate of the monitored application. In practical cases, the predetermined period of time is less than one minute, preferably less than 15 seconds, particularly preferably less than 5 seconds and most preferably less than one second. The period of time may be determined based on the monitored application and/or the kind of additional information which should be retrieved. If the application is a web browser and the additional information relates to prize comparison, a user would expect short update cycles. In this case, the predetermined period of time might be set to 5 seconds or less. If the additional information relates to similar products, a user does not expect instant updates. In this case, the predetermined period of time might be set to 1 minute up to 10 minutes.

According to another embodiment, the method might be triggered by accessing primary information. Each time, the application sends a request regarding the primary information or each time the address information is updated, the method might be triggered. In order to ensure, that the different entities of the system do not waste resources, a threshold might be provided, which defines the minimum time until the method can be triggered anew. This threshold might be set to a value less than one minute or to a value less than one second, dependent on the respectively available performance.

Both embodiments might be combined. In this case, the method might be triggered by accessing primary information. However, if primary information is not accessed within a predetermined period of time, execution of the method might be triggered nevertheless. At this combined embodiment, the predetermined period of time might be set to one or several minutes.

In order to reduce the numbers of forwarding and retrieving steps, a step of comparing address information might be performed before executing the step of forwarding address information. During such a step, the extracted address information might be compared with previously extracted address information, i.e. with address information which was extracted during a previous step of extracting address information. To this extent it is not relevant, whether the “previous step of extracting address information” is the directly preceding iteration of the method or any previous iteration. For the sake of saving memory, the number of iterations regarding the “previous step of extracting address information” might be limited. For instance, the number of iterations might be limited to less than 20. In case the extracted address information equals the previously extracted address information, the step of forwarding extracted address information might be omitted for this iteration of the method. If the extracted address information differs from the previously extracted address information, the step of forwarding extracted address information might be executed.

For improving the quality of the retrieved additional information, the retrieving entity might use the extracted address information and might access the primary information, as well. By doing so, the retrieving entity might gain further information regarding the required additional information. This might be particularly useful, if the additional information does not contain directly readable content information. After accessing the primary information at the retrieving entity, the potentially relevant additional information can be retrieved more easily.

It might also be necessary to provide further data to the retrieving entity, so that the retrieving entity can access the primary information correctly. For instance, a website might use cookies which refines the address information. In this case, it will not be sufficient to forward the primary information and it might be beneficial to forward further data to the retrieving entity.

When additional information is forwarded back to the user equipment, the additional information will be processed by the user equipment. This step of processing might be incorporate various different steps. For example, a filtering operation or aggregation steps might be performed. According to one embodiment processing of the additional data comprises the step of displaying the additional information or parts of the additional information to a user of the user equipment. In a preferred embodiment the additional information is displayed in a predefined area of a display of the user equipment.

When displaying additional information to a user, it might be beneficial to reduce user disturbance as much as possible. To this extend, an option might be provided to the user that only specific additional information is displayed (e.g. by filtering or by shortening text or by otherwise manipulating the manner in which the additional information and/or primary information is displayed). This option may be implemented by preferences which are adaptable and/or customizable by the user. The additional information might be displayed, for example, within an overlay window. The information in the overlay window might be shortened so that the space occupied by displaying the additional information is reduced. If the user is interested in reading the full information, he/she has to access the shortcut for accessing the full additional information. The overlay windows might be displayed in the foreground so that it is not covered by other applications. The overlay windows might be adaptable, e.g. regarding to its size, shape and/or position. The overlay windows might also be implemented by the notification function which is provided by several operating systems, e.g. Apple iOS or Microsoft Windows 10.

According to one embodiment, the system interface is provided by an enhanced accessibility function provided by the operating system. Many operating systems provide functions that supports persons with reduced ability to see at using the user equipment. For instance, such an enhanced accessibility function might be used by a Braille output device or a speech output system. In order to provide content information to such enhanced accessibility functions, the operating system generates data objects that contain information of the respective application, for instance a browser window. In this embodiment of the invention, the enhanced accessibility function would be triggered to generate an according data object and the data object will be searched for relevant address information. The monitoring entity identifies itself as a device for enhanced accessibility. It can be necessary to grant access to the retrieving system during its setup.

In case the operating system is formed by Microsoft Windows, the Windows Standard Development Kit (SDK) provides different tools for analyzing extracted information as a tree structure. Applications, which support the Microsoft Active Accessibility API (MSAA), enable MSAA clients to run through a hierarchy of objects. These objects have different properties, like roles or values. The roles represent elements of graphical user interfaces that are commonly used at MSAA. Although there are no specific roles for internet addresses, browser URL (Uniform Resource Locator) are contained in the role “AccessibleRole.Text”. By using URL recognition, texts that are not internet addresses can be filtered out.

According to another embodiment of the system interface, user interface automation functions of the operating system are used. Many operating systems provide the ability to automate user interaction with applications, in order to control an application in a predetermined way. If the operating system is formed by Microsoft Windows, such a user interface automation might be formed by the .net framework. The according tree structure might be searched in an easy manner. It might be reasonable to additionally use the .com version of the UI automation API (Application Program Interface). In some cases, searching a full tree structure for according address information might be time-consuming. Then searching parts of the tree structures until a valid address is found might form a reasonable compromise.

In order to improve performance and/or adaptability of the system, the forwarding entity might be connected to an evaluation entity. The evaluation entity might be configured to receive the extracted address information and to decide whether the extracted address information is forwarded to the retrieving entity. By providing such an evaluation entity, preferences of the user can be considered. A user might define address information, for which additional information are desired. These pieces of address information might be contained in a whitelist. Additionally, or alternatively, the user might define those pieces of address information, for which no additional information are desired. These pieces of address information might be contained in a blacklist. By evaluating such a blacklist and/or whitelist, the evaluation entity can decide, whether extracted address information is forwarded to the retrieving entity and whether additional information should be retrieved.

The retrieving entity might be connected to a database. This database might store links between extracted address information and additional information. Such a database may, for instance, be a price comparison database that is constantly updated. Such databases are well known in the art.

The retrieving entity might be implemented on the user equipment and/or on a server. If a server is provided, it will be connected to the user equipment via the network. It is also possible that parts of the retrieving entity are implemented in the user equipment and parts are implemented on a server. However, according to a preferred embodiment, the retrieving entity is implemented on the server, so that greater performance can be made available for the retrieving entity.

In case several applications should be monitored, a monitoring entity and/or a forwarding entity can be provided for each application to be monitored, respectively. The several applications can be formed by several instances of an application or by different tabs of a web browser. In order to improve performance, it can be beneficial to activate just one monitoring entity, namely the monitoring entity that is responsible for the currently active application. At operating systems like Microsoft Windows, the currently active application might be formed by the window that currently has the focus. A supervising entity can be provided, which coordinates the multiple monitoring and/or forwarding entities. The supervising entity may also detect new application to be monitored and may start a new monitoring entity and/or forwarding entity.

The method according to the invention is also, according to certain embodiments, implemented as a computer program product. The computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

The computer program product might also, according to various embodiments, be implemented as a Software Development Kit (SDK) or as an independent program product. The computer program product might be also beneficially designed as a software development module for a SDK, which does not have own search routines and which provides an interface for handing over search parameters, particularly extracted address information. Thus, a so-called white label application can be provided that might be adaptable for different providers to the corporate identity. Besides that, the computer program product can be designed technically configurable and scalable. Also the user interface may be designed adaptable.

### BRIEF DESCRIPTION OF THE FIGURES

There are several ways how to design and further develop the teaching of the present invention in an advantageous way. To this end, it is to be referred to the dependent patent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawings:

FIG. 1 is a diagram that illustrates a first embodiment of a system according to the invention,

FIG. 2 is a diagram that illustrates a second embodiment of a system according to the invention with several monitoring entities,

FIG. 3 is a schematic block diagram of a user equipment according to various embodiments, and

FIG. 4 is a schematic block diagram of an exemplary mobile device according to various embodiments.

### DETAILED DESCRIPTION OF VARIOUS EMBODIMENTS

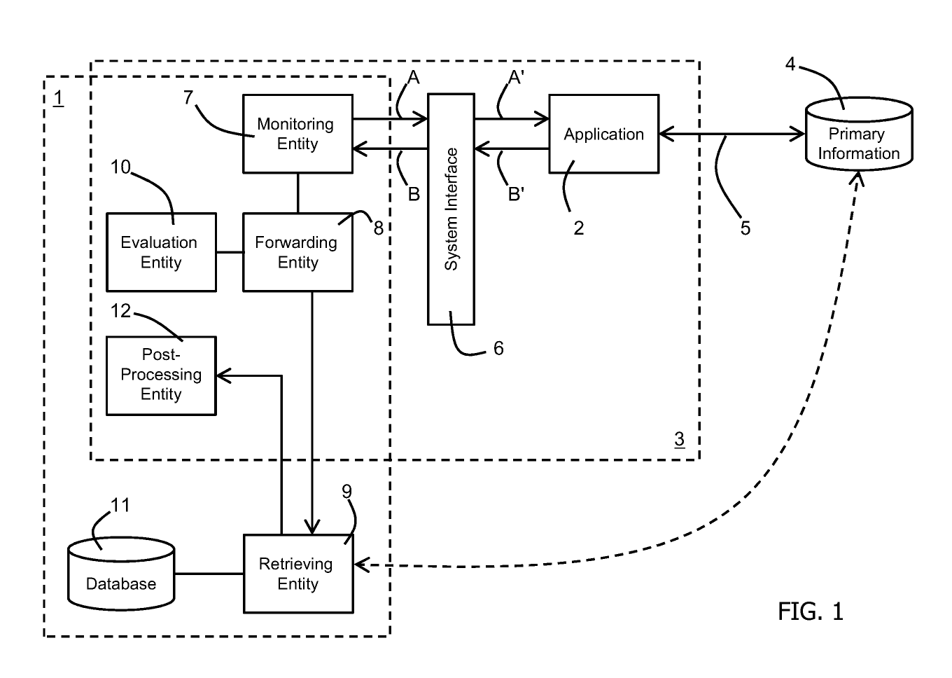

FIG. 1 shows a diagram of a first embodiment of a retrieving system 1 according to the invention. An application 2 is running on a user equipment (indicated by a dotted box 3). The application 2 can access primary information 4 via a network link 5, e.g. the Internet. The primary information 4 is stored at a remote server. An operating system is running on the user equipment 3. One part of the operating system is a system interface 6. In the embodiment according to FIG. 1, the system interface 6 is formed by an enhanced accessibility function of the operating systems.

The retrieving system 1 comprises a monitoring entity 7, a forwarding entity 8, a retrieving entity 9, an evaluation entity 10, a database 11 storing additional information or links to additional information, and a post-processing entity 12. The monitoring entity 7 is connected to the forwarding entity 8. The forwarding entity 8 is further connected to the evaluation entity 10 and the retrieving entity 9. The retrieving entity may communicate with the database 11 and the post-processing unit 12. In this embodiment, the monitoring entity 7, the forwarding entity 8, the evaluation entity 10 and the post-processing entity 12 are also running on the user equipment 3. The retrieving entity 9 and the database 11 are implemented on one or more remote servers. The retrieving entity 9 may also access the primary information 4.

During operation, the monitoring entity 7 monitors the application 2 and can extract address information from the application 2 via the system interface 6. To this extend, the monitoring entity 7 may send a system call A to the system interface 6. The system interface 6 interacts with the application (requests A′ and responses B′) and generates a data object containing the desired data. The data object is transmitted to the monitoring entity 7 via a response B. The monitoring entity extracts address information from the data object. This extracted address information is an identical or a shortened copy of address information used at the application for accessing the primary information 4. The address information may, for instance, be contained in an input box of the application 2. After extraction of the address information, the monitoring entity 7 forwards the extracted address information to the forwarding entity 8.

The forwarding entity 8 sends the extracted address information to the evaluation entity 10. The evaluation entity 10 decides, whether the extracted address information may be forwarded to the retrieving entity 9. To that extent, the evaluation entity 10 may access a whitelist and/or a blacklist and may compare the extracted address information with the entries. If the extracted address information can be found in the whitelist, the extracted address information can be forwarded to the retrieving entity 9. If the extracted address information can be found in the blacklist, the extracted address information must not be forwarded to the retrieving entity 9. If the extracted address information cannot be found in the whitelist and cannot be found in the blacklist, the decision may be taken in different ways. It might be possible to send the extracted address information to an external evaluation system that evaluates the address based on heuristic approaches. It might be possible to ask the user of the user equipment, whether additional information should be retrieved. However, in most such cases, the address information will not be forwarded to the retrieving entity, in order to be least annoying for the user. The address information may be added to a protocol list so that the user can whitelist or blacklist the address information later.

Additionally, or alternatively, the evaluation entity 10 may store received extracted address information and may compare newly received extracted address information with stored extracted address information (i.e. with previously received extracted address information). If the newly received extracted address information differs from previously received extracted address information, the extracted address information may be forwarded to the retrieving entity. If the newly received extracted address information can be found in the stored address information, the newly received extracted address may be discarded.

The evaluation entity 10 communicates a forwarding decision back to the forwarding entity 8. If the forwarding decision does not allow forwarding of the extracted address information, the forwarding entity 8 will discard the extracted address information. If the forwarding decision allows forwarding, the forwarding entity 8 forwards the extracted address information to the retrieving entity 9.

The retrieving entity 9 retrieves additional information based on the extracted address information. In order to fulfil this task, the retrieving entity 9 may access the database 11 that stores additional information or links between address information and additional information. The additional information might be present at the database 11 or might be accessible via a link to another resource. These links between address information and additional information might refer to cheaper offers of other retailer, might refer to reviews or vouchers or might refer to various other pieces of additional information. If the extracted address information is not suitable for retrieving additional information, the retrieving entity 9 may additionally access the primary information for retrieving more details of the primary information.

The results of this retrieving step are communicated back to the user equipment 3. If no additional information can be found, the results will be an empty list. However, in most cases, additional information will be found and the results will contain one or several entries. At the user equipment 3, the results are received by the post-processing entity 12. This post-processing entity 12 may apply filters on the results. It may aggregate the received pieces of information. Additionally, or alternatively, it may initiate displaying of the results (in original or processed form) to the user.

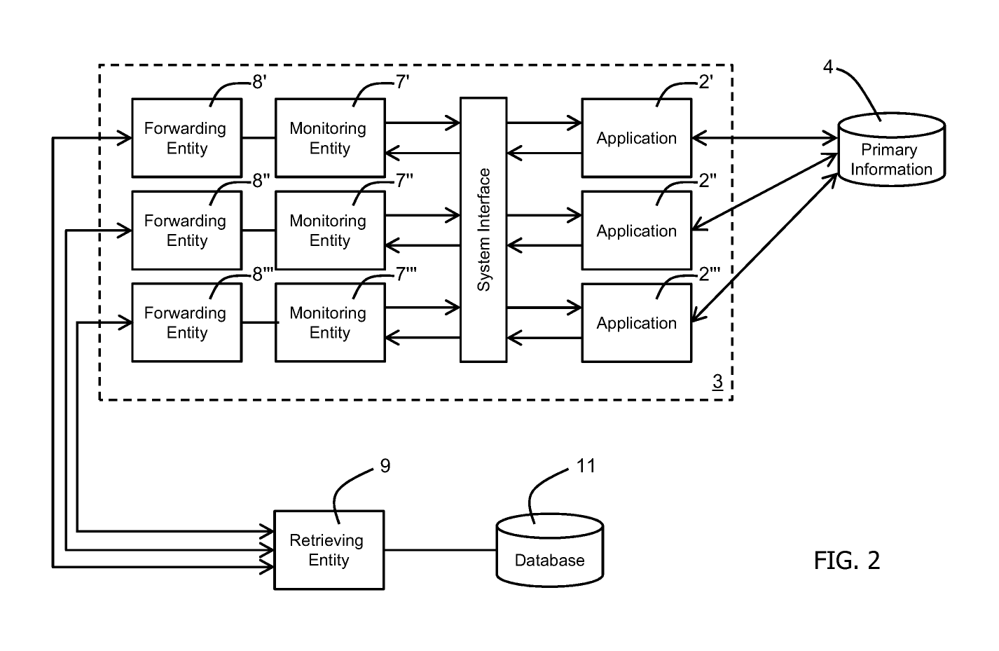

FIG. 2 shows a second embodiment of the retrieving system 1′ according to the invention that uses several monitoring and several forwarding entities for several applications. In the embodiment of FIG. 2, three applications 2′, 2″ and 2′″ are running on the user equipment 3 and may access primary information 4. Although FIG. 2 shows one source of primary information 4, it is not necessary that each application accesses the same piece of primary information 4. In most cases, each application will access different primary information.

The system of FIG. 2 provides three monitoring entities 7′, 7″, 7′″ and three forwarding entities 8′, 8″, 8′″, where one monitoring entity and one forwarding entity is associated with one application, respectively. For the sake of clarity, no evaluation entities are shown. However, the system may also comprise one or several evaluation entities. In the embodiment of FIG. 2, the forwarding entities 8′, 8″, 8′″ communicate with one retrieving entity 9. A supervising entity may be provided (not shown) that identifies potentially relevant applications. Each time a potentially relevant application is identified, the supervising entity may start a new monitoring entity and a new forwarding entity. Besides that, the system works identical to the system shown in FIG. 1.

The invention and its embodiments disclosed here, is universally applicable. In connection with the preferred application scenario, a shopping system, it can be used for providing additional information to a user regarding cheaper offers by another retailer, available vouchers, product reviews, technical information, availability or shipping charges at other retailers, etc. The additional information can support a user at collecting relevant information regarding an accessed product.

As mentioned previously, the various embodiments of the present invention may be implemented in various ways, including as a computer program product. The computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, these embodiments of the present invention may also be implemented as methods, apparatus, systems, computing devices, computing entities, and/or the like, all as previously described herein. As such, embodiments of the present invention may take the form of an apparatus, system, computing device, computing entity, and/or the like executing instructions stored on a computer-readable storage medium to perform certain steps or operations.

Various embodiments will now be described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

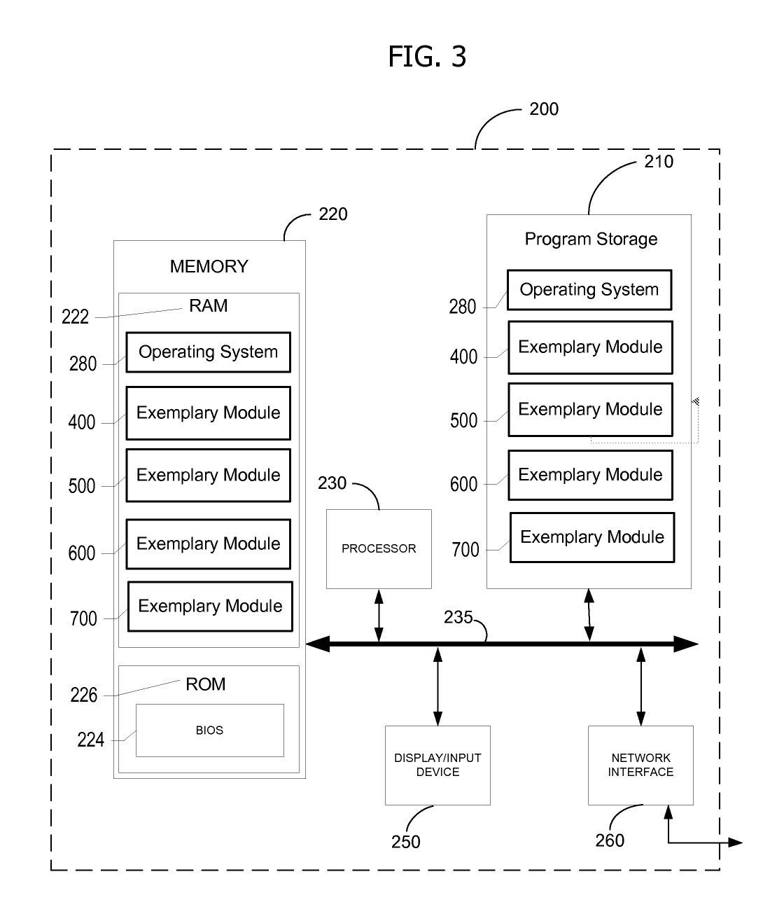

FIG. 3 illustrates a block diagram of user equipment 200 that might be utilized according to various embodiments of the present invention, including those described previously herein. It should be understood that the user equipment 200 is equivalent to the user equipment 3 described previously herein, with certain components thereof being illustrated as modules, versus entities, as detailed further below.

The user equipment 200 of FIG. 3 includes a processor 230 that communicates with other elements via a bus 235. Also included is a display/input device 250 for receiving and displaying data. This display/input device 250 may be, for example, a keyboard or pointing device that is used in combination with a monitor. The user equipment 200 further includes memory 220, which preferably includes both read only memory (ROM) 226 and random access memory (RAM) 222. The user equipment's ROM 226 is used to store a basic input/output system 224 (BIOS), containing the basic routines that help to transfer information between elements within the user equipment 200. Various ROM and RAM configurations have been previously described herein.

In addition, the user equipment 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 210 and/or memory of the user equipment 200 may further provide the functions of a data storage device, which may any of a variety of data that may be accessed by the user equipment 200. In this regard, the storage device 210 may comprise one or more databases. The term “database” refers to a structured collection of records or data that is stored in a computer system, such as via a relational database, hierarchical database, or network database and as such, should not be construed in a limiting fashion. The term “database” in this context, should also be considered interchangeable with the database 11 described previously herein.

Remaining with FIG. 3, a number of program modules (e.g., exemplary modules 400-700) comprising, for example, one or more computer-readable program code portions executable by the processor 230, may be stored by the various storage devices 210 and within RAM 222. Such program modules may also include an operating system 280 (which should also be considered interchangeable and/or analogous to the operating system (not numbered) described previously herein). In these and other embodiments, the various modules 400, 500, 600, 700 control certain aspects of the operation of the user equipment 200 with the assistance of the processor 230 and operating system 280. In still other embodiments, it should be understood that one or more additional and/or alternative modules may also be provided, without departing from the scope and nature of the present invention.

In various embodiments, the program modules 400, 500, 600, 700 are executed by the user equipment 200 and are configured to generate one or more graphical user interfaces, reports, instructions, and/or notifications/alerts, all accessible and/or transmittable to various users. In certain embodiments, the user interfaces, reports, instructions, and/or notifications/alerts may be accessible via one or more networks 130, which may include the Internet or other feasible communications network, as previously discussed.

In various embodiments, it should also be understood that one or more of the modules 400, 500, 600, 700 may be alternatively and/or additionally (e.g., in duplicate) stored locally or on a central server (or elsewhere), as also described previously herein. According to various embodiments, the modules 400, 500, 600, 700 may send data to, receive data from, and utilize data contained in one or more databases, which may be comprised of one or more separate, linked and/or networked databases.

In various embodiments, it should also be understood that one or more of the modules 400, 500, 600, 700 are interchangeable and/or analogous to any one or more of the monitoring entities 7, 7′, 7″, 7′″; the forwarding entities 8, 8′, 8″, 8′″; the evaluation entity 10; the post-processing entity 12; and/or the retrieving entity 9—all as previously described herein. Specifically, as stated previously herein, the entities listed above may be implemented as modules, which should be understood in this context with reference to FIG. 3.

Also located within the user equipment 200 according to certain embodiments is a network interface 260 for interfacing and communicating with other elements of the one or more networks. It will be appreciated by one of ordinary skill in the art that one or more of the user equipment 200 components may be located geographically remotely from other server components. For example, as detailed previously herein, the retrieving entity 9 (or an exemplary module representative thereof) may not be located on the user equipment 200 itself; it may instead be located on a remote server.

Still further, while the foregoing describes a single processor 230, as one of ordinary skill in the art will recognize, the user equipment 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the user equipment 200 to receive data from a user, such as a keypad, a touch display, a joystick or other input device.

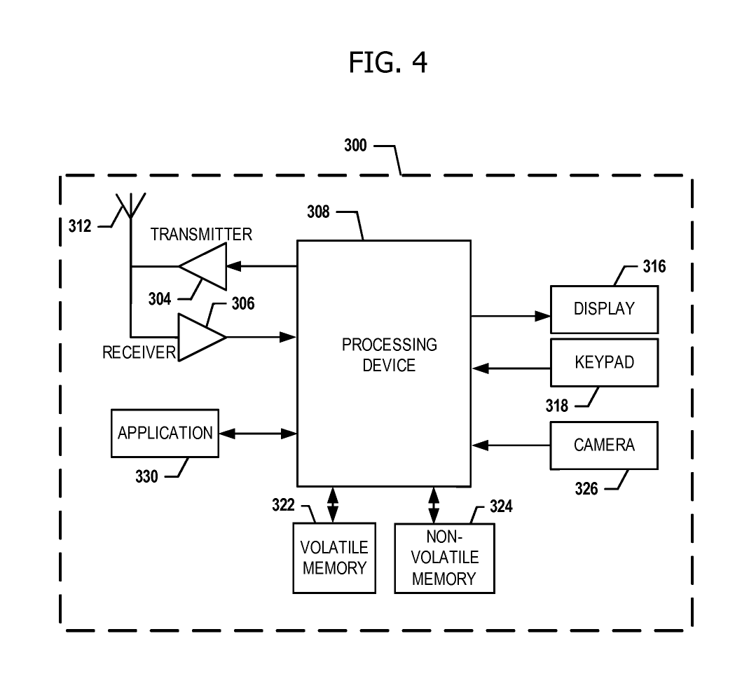

FIG. 4 provides an illustrative schematic representation of a mobile version of the user equipment 3, as previously described herein. The mobile version 300 may likewise be used in conjunction with various embodiments of the present invention. As shown in FIG. 4, the mobile version or device 300 may include an antenna 312, a transmitter 304 (e.g., radio), a receiver 306 (e.g., radio), and a processing element 308 that provides signals to and receives signals from the transmitter 304 and receiver 306, respectively.

The signals provided to and received from the transmitter 304 and the receiver 306, respectively, may include signaling data in accordance with an air interface standard of applicable wireless systems to communicate with various entities, such as the user equipment 3, the user equipment 200, and/or the like. In this regard, the mobile device 300 may be capable of operating with one or more air interface standards, communication protocols, modulation types, and access types. More particularly, the mobile device 300 may operate in accordance with any of a number of wireless communication standards and protocols. In a particular embodiment, the mobile device 300 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 300 can also download changes, add-ons, and updates, for instance, to its firmware, software (e.g., including executable instructions, applications, program modules), and operating system.

According to one embodiment, the mobile device 300 may include a location determining device and/or functionality. For example, the mobile device 300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 300 may also comprise a user interface (that can include a display 316 coupled to a processing element 308) and/or a user input interface (coupled to a processing element 308). The user input interface can comprise any of a number of devices allowing the mobile device 300 to receive data, such as a keypad 318 (hard or soft), a touch display, voice or motion interfaces, or other input device. In embodiments including a keypad 318, the keypad can include (or cause display of) the conventional numeric (0-9) and related keys (#, *), and other keys used for operating the mobile device 300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 300 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 300.

The mobile device 300 may also include one or more of a camera 326 and a mobile application 330 (considered interchangeable and/or analogous to the applications 2, 2′, 2″, 2′″—all as previously described herein). The camera 326 may be configured according to various embodiments as an additional and/or alternative data collection feature, whereby one or more items may be read, stored, and/or transmitted by the mobile device 300 via the camera. The mobile application 330 may further provide a feature via which various tasks may be performed with the mobile device 300; it should be understood that the mobile application 330 may be configured substantially the same as (and thus provide comparable functionality as) the applications 2, 2′, 2″, 2′″ previously described herein. Various configurations may be provided, as may be desirable for one or more users of the mobile device 300 (and/or the invention described herein) as a whole.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### LIST OF REFERENCE SIGNS

1 Retrieving System
2 Application
3 User Equipment
4 Storage for primary information
5 Network Link
6 System Interface
7 Monitoring Entity
8 Forwarding Entity
9 Retrieving Entity
10 Evaluation Entity
11 Database (storing additional information
12 Post-Processing Entity
A System Call
B Response with Address Information
200 User Equipment
210 Program Storage
220 Memory
222 RAM
224 BIOS
226 ROM
230 Processor
235 Bus
250 Display/Input Device
260 Network Interface
280 Operating System
400 Exemplary Module
500 Exemplary Module
600 Exemplary Module
700 Exemplary Module
300 Mobile Device
304 Transmitter
306 Receiver
308 Processing Device
312 Antenna
316 Display
318 Keypad
322 Volatile Memory
324 Non-Volatile Memory
326 Camera
330 Application

1. Method for providing additional information relating to primary information accessible via a network, said method comprising the steps of:
providing a retrieving entity and a user equipment, said user equipment comprising a processor and an operating system, said operating system comprising a system interface;
accessing or referencing primary information via an application using address information, said application running on said user equipment and being executed by said processor;
extracting said address information via the system interface, thus generating extracted address information;
generating a data object via the system interface, wherein said data object comprises said generated extracted address information;
transmitting said extracted address information to said retrieving entity;
retrieving, via execution of the retrieving entity, additional information based on said extracted address information; and
transmitting said additional information to said user equipment for further processing.

2. Method according to claim 1, wherein said step of extracting address information comprises reading a text string from an according input box of said application.

3. Method according to claim 1, said method being repeatedly performed, wherein said method is triggered after lapse of a predetermined period of time, respectively.

4. Method according to claim 1, said method being repeatedly performed, wherein said method being triggered by accessing primary information by said application, and wherein a threshold may be provided, said threshold defining the minimum time until said method can be triggered anew.

5. Method according to claim 1, wherein, before performing the step of forwarding extracted address information, said extracted address information is compared with previously extracted address information, wherein said previously extracted address information are extracted during a previous step of extracting address information, and wherein said step of forwarding extracted address information is performed only if the extracted address information differs from the previously extracted address information.

6. Method according to claim 1, wherein, for improving retrieval of additional information, said step of retrieving additional information includes a step of accessing said primary information.

7. Method according to claim 1, additionally comprising a step of displaying said additional information to a user of said user equipment.

8. Method according to claim 7, wherein said additional information is displayed to said user of said user equipment in a predefined area of a display of said user equipment.

9. Method according to claim 1, wherein the network is the Internet.

10. Method according to claim 1, wherein the further processing of said additional information comprises receiving and displaying, at the user equipment, said additional information, said receiving and displaying comprising generation, via the processor, of a customized overlay window illustrating at least a portion of the additional information.

11. Method according to claim 1, wherein the user equipment comprises a memory and a processor, one or more steps of said method being executed via the processor of the user equipment.

12. System for providing additional information relating to primary information accessible via a network, said system comprising:
a user equipment running an operating system and at least one application, wherein said at least one application is configured to access said primary information via said network using address information;
a monitoring entity, said monitoring entity running on said user equipment and being configured to generate extracted address information by extracting said address information via a system interface provided by said operating system, wherein said extracted address information is part of a data object generated by said system interface;
a retrieving entity; and
a forwarding entity configured to transmit said extracted address information to said retrieving entity,
wherein said retrieving entity is configured to retrieve additional information based on said extracted address information and to transmit said additional information to said user equipment for further processing.

13. System according to claim 12, wherein said system interface is provided by an enhanced accessibility function of the operating system.

14. System according to claim 12, wherein said system interface is provided by a user interface automation function of the operating system.

15. System according to claim 12, wherein said forwarding entity is connected to an evaluation entity, said evaluation entity being configured to receive said extracted address information and to decide, whether the extracted address information is forwarded to said retrieving entity.

16. System according to claim 12, wherein said retrieving entity is connected to a database, said database storing links between extracted address information and additional information.

17. System according to claim 12, wherein said retrieving entity is implemented on said user equipment and/or on a server, wherein said server is connected to said user equipment via a network.

18. System according to claim 12, wherein, in case of the presence of several applications, a monitoring entity and/or forwarding entity is provided for each application to be monitored.

19. A computer program product comprising at least one non-transitory computer-readable storage medium having computer-readable program code portions embodied therein, the computer-readable program code portions comprising at least one executable portion configured for:
accessing or referencing primary information via an application using address information, said application running on a user equipment and being executed by a processor of said user equipment, said user equipment further comprising an operating system, said operating system comprising a system interface;
extracting said address information via the system interface, thus generating extracted address information;
generating a data object via the system interface, wherein said data object comprises said generated extracted address information;
transmitting said extracted address information to a retrieving entity;
retrieving, via execution of the retrieving entity, additional information based on said extracted address information; and
transmitting said additional information to said user equipment for further processing.

20. Computer program product according to claim 19, wherein the at least one executable portion is configured for performing one or more of the recited steps using modules of said operating system.
